(19) United States
(12) Patent Application Publication
(10) Pub. No.: US 2011/0010759 A1
(43) Pub. Date: Jan. 13, 2011

(54) PROVIDING A CUSTOMIZED INTERFACE FOR AN APPLICATION STORE

(75) Inventor: Mitchell Adler, Cupertino, CA (US)

Correspondence Address: APPLE INC./BSTZ;BLAKELY SOKOLOFF TAYLOR & ZAFMAN LLP, 1279 OAKMEAD PARKWAY, SUITE 300, SUNNYVALE, CA, 94085-4040, US

(73) Assignee: Apple Inc., Cupertino, CA (US)

(21) Appl. No.: 12/649,139

(22) Filed: Dec. 29, 2009

Related U.S. Application Data
(60) Provisional application No. 61/224,421, filed on Jul. 9, 2009.

(51) Int. Cl. G06F 21/00

(52) U.S. Cl. 726/4

(57) ABSTRACT

Embodiments of the present disclosure provide a system and method of providing customized access to an electronic storefront for downloading software for a mobile device based on authorization data stored on the mobile device. In one embodiment, mobile devices have stored one or more profile. Each profile is signed by a particular entity (a particular developer or enterprise) and includes authorization data authorizing one or more devices to install and use software associated with the entity. A content management application associated with the storefront (e.g., iTunes) identifies one or more storefronts associated with the entities of authorized profiles for a particular device upon access to the storefront and provides the entity storefronts to a user of the device based on the authorization data stored on the device. In one embodiment, a profile is authorized, e.g., using encryption and installed to the device by the particular entity. Software for which distribution is limited to those authorized by an enterprise or other entity is thus only available for download to a properly profiled and authorized device.

### RELATED APPLICATION

This application claims priority to co-pending U.S. Provisional Application Ser. No. 61/224,421, filed on Jul. 9, 2009, the disclosure of which is hereby incorporated by reference for all purposes.

### BACKGROUND

1. Field

This application relates to providing access to a source of software that can be downloaded or installed on a computing device.

2. Description of the Related Technology

Modern computing devices, such as computers, mobile computing devices, and mobile phones, are capable of downloading and installing a wide variety of software applications. For example, software sources, such as Apple's App Store, allow users to browse and download applications onto their computing devices. For example, Apple's App Store and others like it allow users to download various applications to their mobile devices, such as their mobile phone. Currently, there are an extremely large number of applications available through sources like the App Store.

Different users and computing devices, however, may have different requirements regarding how these applications execute. For example, computing devices may be configured to require that any code executed be authorized by a trusted party. As another example, certain applications may be deemed unsuitable or unsafe for a particular user. Unfortunately, due to the extremely large number of applications, it can be difficult to manage the availability and installation of these applications.

### BRIEF DESCRIPTION OF THE DRAWINGS

A better understanding of the present invention can be obtained from the following detailed description in conjunction with the following drawings, in which:

FIG. 1 is an example of an environment suitable for practicing various embodiments described herein.

FIGS. 2A and 2B illustrate an exemplary mobile device.

FIG. 3 is a block diagram of an example implementation of a mobile device.

FIG. 4 illustrates a conceptual block diagram of an environment on the computing device that supports embodiments of the present disclosure.

FIGS. 5A and 5B illustrate an exemplary process flow for providing customized front-end interface to a source of software and installing an application from the source.

FIG. 6 illustrates an exemplary process for executing an application that has been installed on a computing device.

### DETAILED DESCRIPTION

Embodiments of the present disclosure provide a system and method of providing customized access to an electronic storefront for downloading software for a mobile device based on authorization data stored on the mobile device. In one embodiment, mobile devices have stored one or more profiles. Each profile may be signed by a particular entity (a particular developer or enterprise) and includes authorization data authorizing one or more devices to install and use software associated with the entity. A content management application associated with a source of software identifies one or more front-end interfaces associated with the entities of authorized profiles for a particular device. The content management application also provides the front-end interfaces to a user of the device based on the authorization data stored on the device.

In one embodiment, a profile is authorized, e.g., using encryption and installed to the device by the particular entity. Software for which distribution is limited to those authorized by an enterprise or other entity is thus only available for download to a properly profiled and authorized device.

In some embodiments, in order to have its profile installed on a computing device, an entity, such as a carrier or enterprise, may send requests to a trusted authority. This request may specify types of access and functionality that the entity would like devices to have while accessing a software source, such as iTunes. The trusted authority may create a profile, which reflects the entity's desired network policies for those devices on the carrier's network or allows the entity to modify the device appropriately.

When a user requests access to a source of software, such as iTunes, the device may check authorizations specified in the profile to determine the manner in which a source of software can be accessed. For purposes of illustration, exemplary embodiments are described for a mobile phone, such as an iPhone from Apple Inc., which can access a source of software like the iTunes Store. Accordingly, various front-end interfaces may essentially serve as “storefronts” that allow for a more customized or limited access to the applications and content provided by iTunes Store or application stores like it.

This allows various entities to customize how a computing device may access a software source. For example, various front-end interfaces (or storefronts) may be customized to suit the requirements of a specific organization or business. Other front-end interfaces (or storefronts) may be customized to suit the needs of a particular vendor, or type of user, such as a people of different ages, ethnicity, location, or different interests. One skilled in the art will recognize that the embodiments are applicable to a wide variety of computing devices and platforms and different sources of software or content. Moreover, the front-end interfaces can provide a wide variety of customization for accessing a source of content and applications.

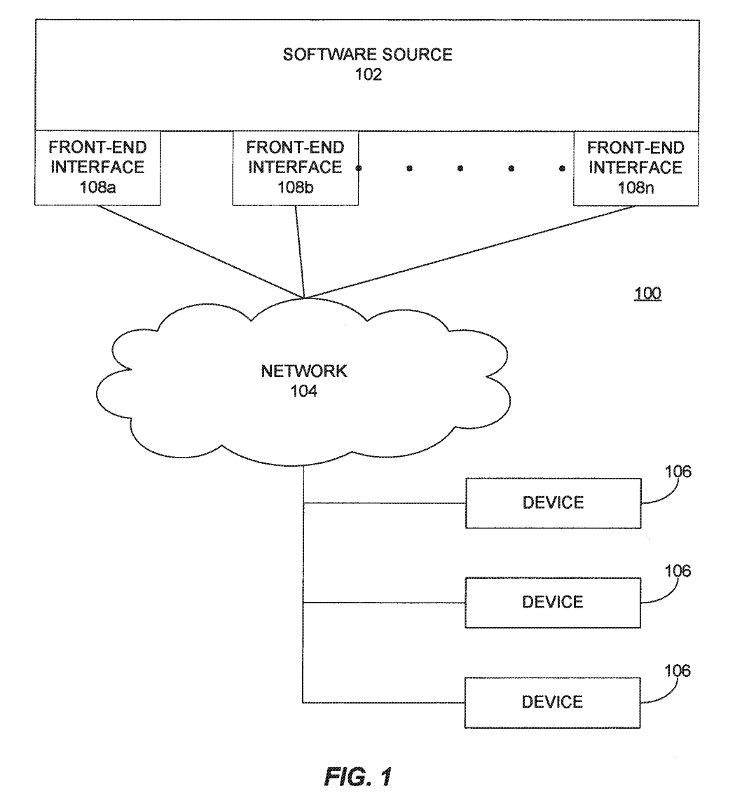

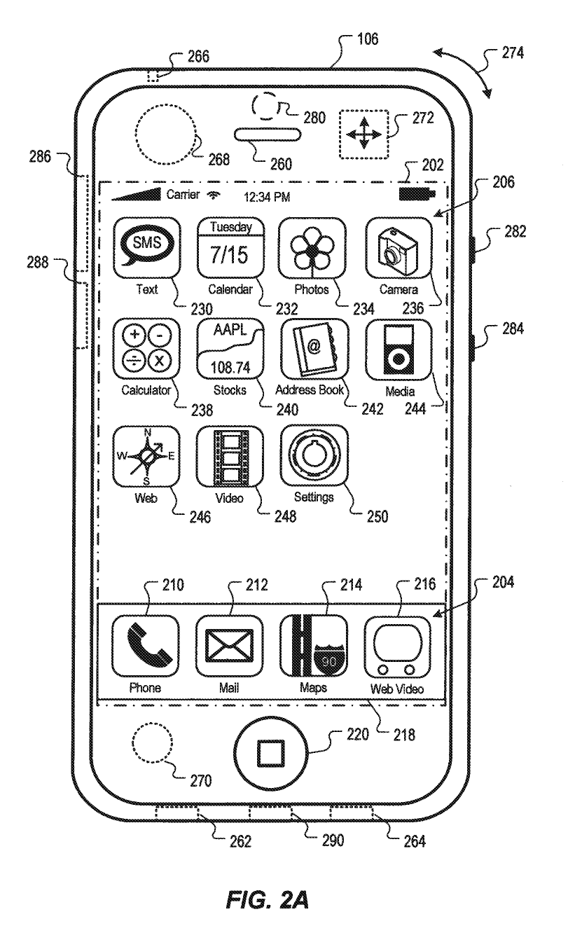

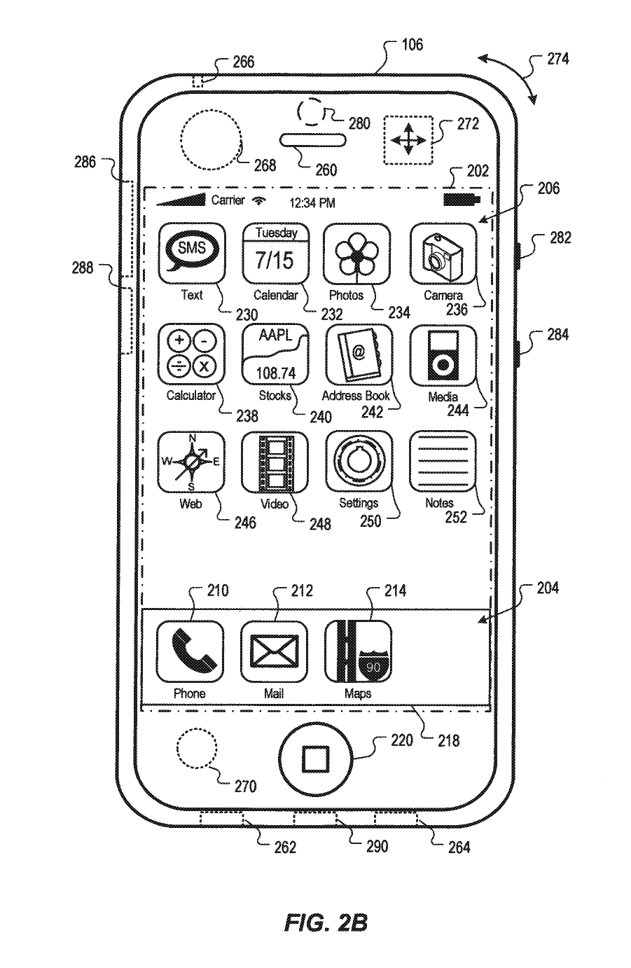

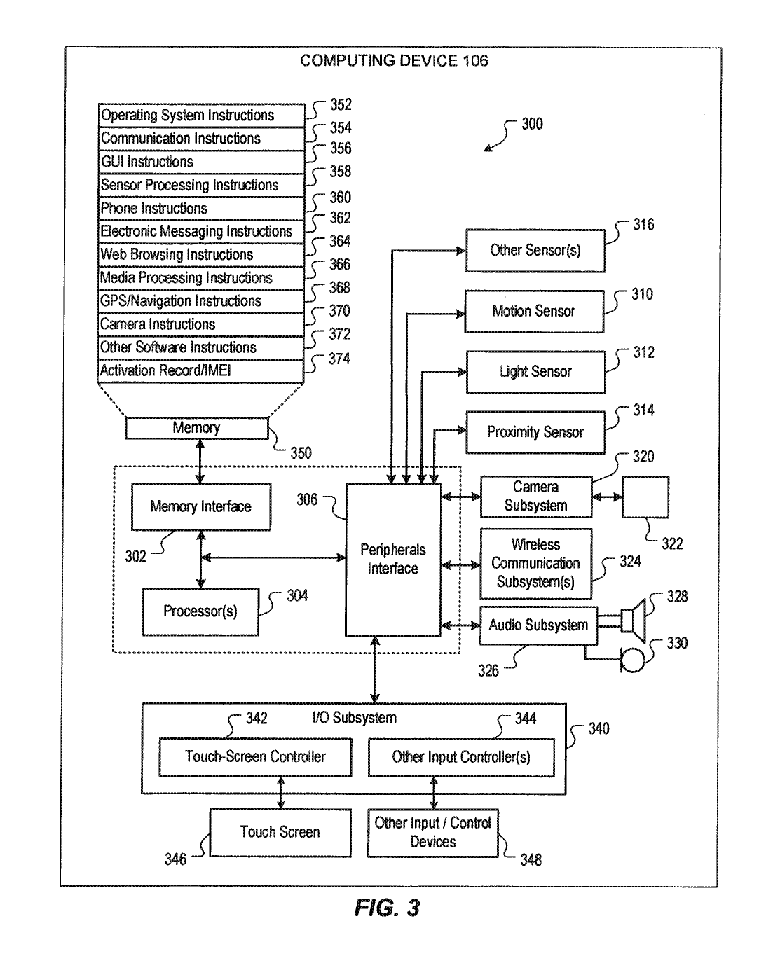

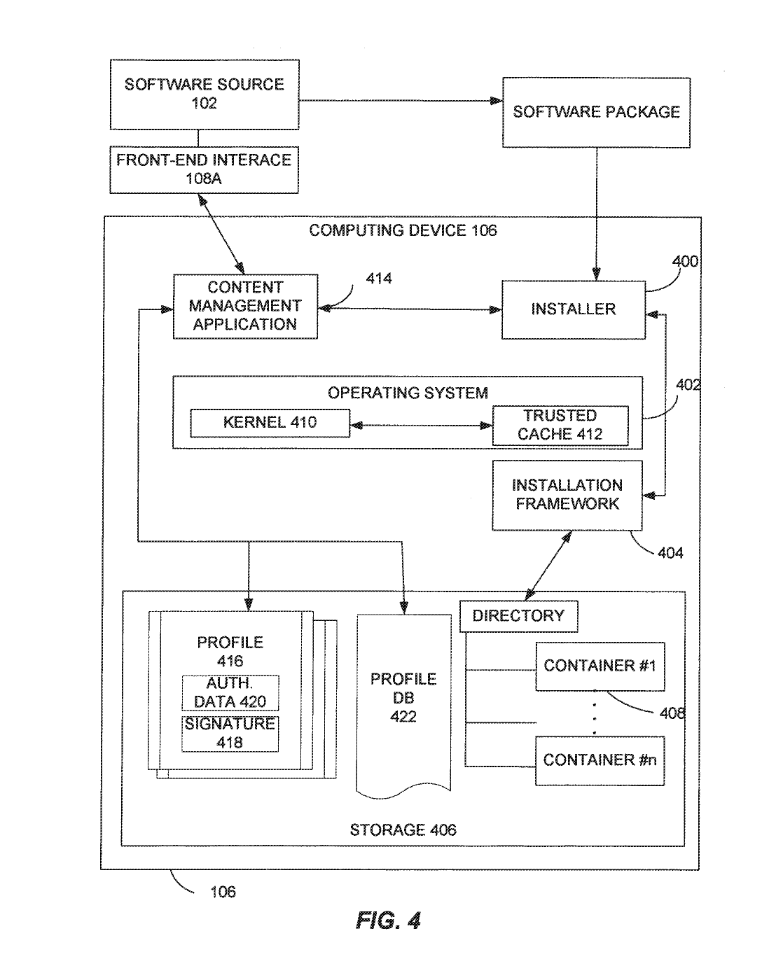

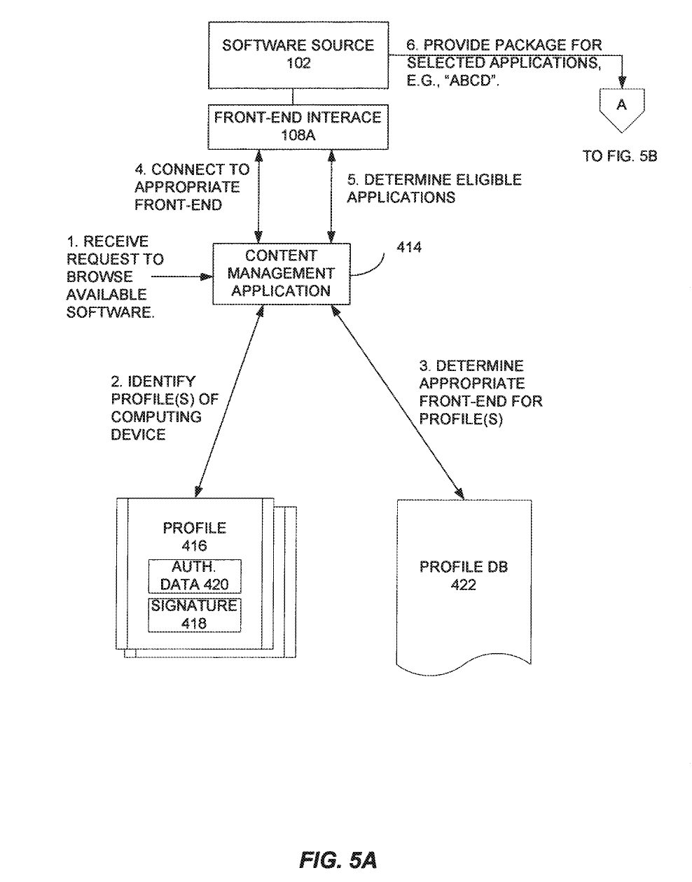

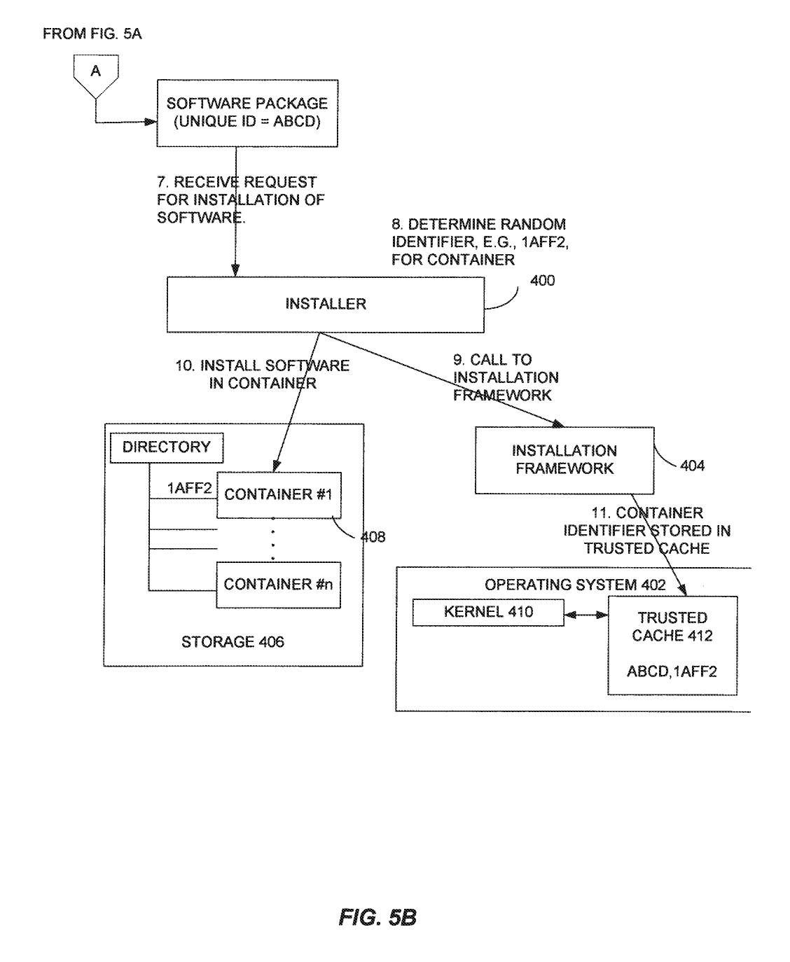

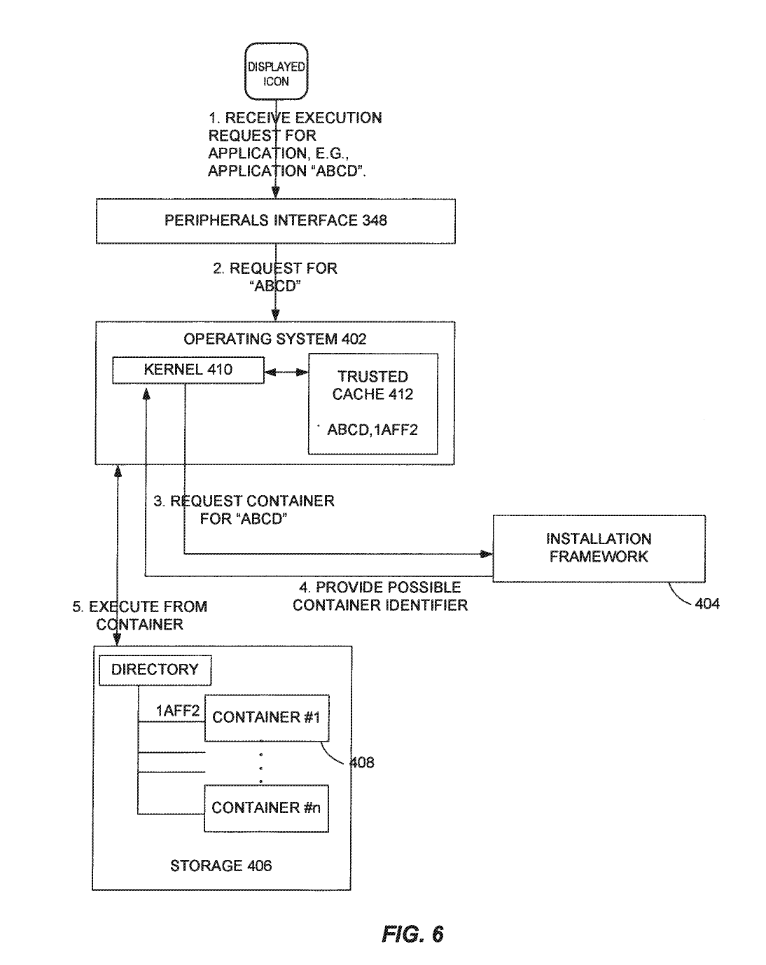

Referring now to the figures, FIG. 1 shows an example of a computing environment in which the embodiments may be implemented. FIGS. 2A-2B and FIG. 3 illustrate an exemplary mobile device. FIG. 4 illustrates a conceptual block diagram of an environment on the computing device 106 that supports customizable front-end interfaces to an application store. FIGS. 5A and 5B illustrate an exemplary process flow for providing customized front-end interface to a source of software, such as an application store, and installing an application from this source. FIG. 6 illustrates an exemplary process for executing an application that has been installed on a computing device. These figures will now be further described below beginning with reference to FIG. 1.

FIG. 1 is an example of an environment suitable for practicing various embodiments described herein. As shown, system 100 may comprise a source 102 for the software and/or program code to be installed, a network 104, and a set of computing devices 106. These entities and components will now be further described.

Source 102 serves as the source of the software or program code to be installed. For example, source 102 can be a website, or service that is accessible to the computing devices 106. In some embodiments, a component of source 102 is an application that runs on the computing device 106 and makes source 102 accessible via the network 104.

For example, the source 102 may be a website or service, which allows users of the computing devices 106 to browse and download applications from an online content and media store. Such media stores may include stores, such as Apple's iTunes Store, App Catalog by Palm Inc., Android Market, Windows Marketplace for Mobile by Microsoft, the Ovi store by Nokia, and BlackBerry App World by Research in Motion.

The applications on source 102 may be available to purchase or may be free of charge, depending on the application. The applications can be downloaded directly to the computing devices 106 as will be further described below.

As also shown, one or more front-end interfaces 108a-n may serve as an application download interface for source 102. In general, each of front-end interfaces 108a-n is an interface defining the ways by which computing device 106 may request certain applications and software from source 102. Accordingly, front-end interfaces 108a-n may provide a customized access to certain applications available in source 102 based on authorization data stored on device 106 and determine which applications are eligible for download and installation on device 106. For example, computing device 106 may comprise one or more stored profiles (not shown in FIG. 1). Each profile may be signed by a particular entity, such as a particular developer or enterprise and can include authorization data. The authorization data authorizes the installation and use software associated with the entity and the profile.

In some embodiments, these profiles are used to determine which of front-end interfaces 108a-n are authorized. For example, in one embodiment, a profile is authorized, e.g., using encryption and installed to device 106 by a particular entity. Software distribution from source 102 can thus be limited to only those authorized by an enterprise or other entity on a properly profiled device 106.

In some embodiments, front-end interfaces 108a-n may be selected at least in part on a cryptographically signed profile of the mobile device. For example, the applications that are deemed eligible for download and installation are selected based at least in part on the identity of the signer of the profile. As shown in FIG. 1, front-end interfaces 108 may be accessible via a network, such as the Internet, when device 106 is a mobile device. Alternatively, front-end interfaces 108 may also be accessible via another computer, such as a host computer or server, which is capable of communicating with computing device 106.

For example, in the examples provided above where source 102 relates to a media store like Apple's iTunes Store, front-end interfaces 108 may be implemented as storefronts. These storefronts may be implemented to have a different appearance, such as color scheme and functions. In addition, a storefront may comprise various content and applications that are only available via the storefront. For example, applications specific to a particular enterprise may be offered via a particular storefront, but is otherwise withheld from other users of source 102.

Device 106 may be configured to allow combinations of front-end interfaces 108. For example, device 106 may be permitted access to multiple front-end interfaces 108 depending on its profile. Furthermore, device 106 may consider multiple profiles in determining which front-end interfaces 108 are accessible.

As will be discussed in more detail below, authorization functionality may be provided by, or in conjunction with, an operating system of device 106, which determines whether the code has been authorized by a trusted authority. If the code is authorized and verified as such, it may be generally executed without any further system or user interaction; if the code is not authorized, its ability to be executed on computing device 106 may be restricted or even prevented. In some embodiments, the computing device may alert the user that the code is not authorized and ask the user if they still wish to execute the unauthorized code. In other embodiments, computing devices 106 may be configured to prevent unauthorized code from being executed at all, regardless of the user's wishes.

In some embodiments, source/trusted authority 102 may authorize software by digitally signing the software. As is known in the art, a digital signature uses public key cryptography to ensure the integrity of data. For example, a software developer may provide source/trusted authority 102 with compiled object code. Source/trusted authority 102 may then create a digital signature with its private key to the object code and may make the code available to computing devices 106.

Network 104 provides a communication infrastructure between computing devices 106 and source 102. Network 104 may be any type of wide-area, metropolitan-area, or local area network. In addition, network 104 may comprise both wired and wireless components.

In some embodiments, network 104 may be implemented on the Internet, which is the well-known global network of interconnected computers, enabling users to share information. The components and protocols employed by network 104 are well known to those skilled in the art.

Computing devices 106 may be any computing device used by a user. Computing devices 106 may be mobile computing devices, such as mobile telephones, mobile smart-phones, or some other type of mobile device. Computing devices 106 may be configured to run an operating system that requires some or all of its software and code to have been securely installed. Thus, if software is delivered or installed in an unauthorized state to computing devices 106, the devices may be unable to fully execute the code instructions included in the software because they have not been properly installed.

Computing devices 106 may be any number of different types of computing devices, including desktop computers, laptop computers, handheld computers, personal digital assistant (PDA) devices, mobile telephone devices, media play device, and the like. For purposes of illustration, various embodiments related to a mobile device are provided. However, one skilled in the art will recognize that the embodiments can be applied to any type of computing device.

FIG. 2A illustrates an example of a mobile device 106. The mobile device 106 can be, for example, a handheld computer, a personal digital assistant, a cellular telephone, a network appliance, a camera, a smart phone, an enhanced general packet radio service (EGPRS) mobile phone, a network base station, a media player, a navigation device, an email device, a game console, or a combination of any two or more of these data processing devices or other data processing devices.

Mobile Device Overview

In some implementations, the mobile device 106 includes a touch-sensitive display 202. The touch-sensitive display 202 can be implemented with liquid crystal display (LCD) technology, light emitting polymer display (LPD) technology, or some other display technology. The touch sensitive display 202 can be sensitive to haptic and/or tactile contact with a user.

In some implementations, the touch-sensitive display 202 can comprise a multi-touch-sensitive display 202. A multi-touch-sensitive display 202 can, for example, process multiple simultaneous touch points, including processing data related to the pressure, degree, and/or position of each touch point. Such processing facilitates gestures and interactions with multiple fingers, chording, and other interactions. Other touch-sensitive display technologies can also be used, e.g., a display in which contact is made using a stylus or other pointing device. Some examples of multi-touch-sensitive display technology are described in U.S. Pat. Nos. 6,323,846, 6,570,557, 6,677,932, and 6,888,536, each of which is incorporated by reference herein in its entirety.

In some implementations, the mobile device 106 can display one or more graphical user interfaces on the touch-sensitive display 202 for providing the user access to various system objects and for conveying information to the user. In some implementations, the graphical user interface can include one or more display objects 204, 206. In the example shown, the display objects 204, 206, are graphic representations of system objects. Some examples of system objects include device functions, applications, windows, files, alerts, events, or other identifiable system objects.

Example Mobile Device Functionality

In some implementations, the mobile device 106 can implement multiple device functionalities, such as a telephony device, as indicated by a Phone object 210; an e-mail device, as indicated by the Mail object 212; a map devices, as indicated by the Maps object 211; a Wi-Fi base station device (not shown); and a network video transmission and display device, as indicated by the Web Video object 216. In some implementations, particular display objects 204, e.g., the Phone object 210, the Mail object 212, the Maps object 214, and the Web Video object 216, can be displayed in a menu bar 218. In some implementations, device functionalities can be accessed from a top-level graphical user interface, such as the graphical user interface illustrated in FIG. 2A. Touching one of the objects 210, 212, 214, or 216 can, for example, invoke a corresponding functionality.

In some implementations, the mobile device 106 can implement a network distribution functionality. For example, the functionality can enable the user to take the mobile device 106 and provide access to its associated network while traveling. In particular, the mobile device 106 can extend Internet access (e.g., Wi-Fi) to other wireless devices in the vicinity. For example, mobile device 106 can be configured as a base station for one or more devices. As such, mobile device 106 can grant or deny network access to other wireless devices.

In some implementations, upon invocation of a device functionality, the graphical user interface of the mobile device 106 changes, or is augmented or replaced with another user interface or user interface elements, to facilitate user access to particular functions associated with the corresponding device functionality. For example, in response to a user touching the Phone object 210, the graphical user interface of the touch-sensitive display 202 may present display objects related to various phone functions; likewise, touching of the Mail object 212 may cause the graphical user interface to present display objects related to various e-mail functions; touching the Maps object 214 may cause the graphical user interface to present display objects related to various maps functions; and touching the Web Video object 216 may cause the graphical user interface to present display objects related to various web video functions.

In some implementations, the top-level graphical user interface environment or state of FIG. 2A can be restored by pressing a button 220 located near the bottom of the mobile device 106. In some implementations, each corresponding device functionality may have corresponding “home” display objects displayed on the touch-sensitive display 202, and the graphical user interface environment of FIG. 2A can be restored by pressing the “home” display object.

In some implementations, the top-level graphical user interface can include additional display objects 206, such as a short messaging service (SMS) object 230, a Calendar object 232, a Photos object 234, a Camera object 236, a Calculator object 238, a Stocks object 240, a Address Book object 242, a Media object 244, a Web object 246, a Video object 248, a Settings object 250, and a Notes object (not shown). Touching the SMS display object 230 can, for example, invoke an SMS messaging environment and supporting functionality; likewise, each selection of a display object 232, 234, 236, 238, 240, 242, 244, 246, 248, and 250 can invoke a corresponding object environment and functionality.

Additional and/or different display objects can also be displayed in the graphical user interface of FIG. 2A. For example, if the device 106 is functioning as a base station for other devices, one or more “connection” objects may appear in the graphical user interface to indicate the connection. In some implementations, the display objects 206 can be configured by a user, e.g., a user may specify which display objects 206 are displayed, and/or may download additional applications or other software that provides other functionalities and corresponding display objects.

In some implementations, the mobile device 106 can include one or more input/output (I/O) devices and/or sensor devices. For example, a speaker 260 and a microphone 262 can be included to facilitate voice-enabled functionalities, such as phone and voice mail functions. In some implementations, an up/down button 284 for volume control of the speaker 260 and the microphone 262 can be included. The mobile device 106 can also include an on/off button 282 for a ring indicator of incoming phone calls. In some implementations, a loud speaker 264 can be included to facilitate hands-free voice functionalities, such as speaker phone functions. An audio jack 266 can also be included for use of headphones and/or a microphone.

In some implementations, a proximity sensor 268 can be included to facilitate the detection of the user positioning the mobile device 106 proximate to the user's ear and, in response, to disengage the touch-sensitive display 202 to prevent accidental function invocations. In some implementations, the touch-sensitive display 202 can be turned off to conserve additional power when the mobile device 106 is proximate to the user's ear.

Other sensors can also be used. For example, in some implementations, an ambient light sensor 270 can be utilized to facilitate adjusting the brightness of the touch-sensitive display 202. In some implementations, an accelerometer 272 can be utilized to detect movement of the mobile device 106, as indicated by the directional arrow 274. Accordingly, display objects and/or media can be presented according to a detected orientation, e.g., portrait or landscape. In some implementations, the mobile device 106 may include circuitry and sensors for supporting a location determining capability, such as that provided by the global positioning system (GPS) or other positioning systems (e.g., systems using Wi-Fi access points, television signals, cellular grids, Uniform Resource Locators (URLs)). In some implementations, a positioning system (e.g., a GPS receiver) can be integrated into the mobile device 106 or provided as a separate device that can be coupled to the mobile device 106 through an interface (e.g., port device 290) to provide access to location-based services.

In some implementations, a port device 290, e.g., a Universal Serial Bus (USB) port, or a docking port, or some other wired port connection, can be included. The port device 290 can, for example, be utilized to establish a wired connection to other computing devices, such as other communication devices 106, network access devices, a personal computer, a printer, a display screen, or other processing devices capable of receiving and/or transmitting data. In some implementations, the port device 290 allows the mobile device 106 to synchronize with a host device using one or more protocols, such as, for example, the TCP/IP, HTTP, UDP and any other known protocol.

The mobile device 106 can also include a camera lens and sensor 280. In some implementations, the camera lens and sensor 280 can be located on the back surface of the mobile device 106. The camera can capture still images and/or video.

The mobile device 106 can also include one or more wireless communication subsystems, such as an 802.11 b/g communication device 286, and/or a Bluetooth™ communication device 288. Other communication protocols can also be supported, including other 802.x communication protocols (e.g., WiMax, Wi-Fi, 3G), code division multiple access (CDMA), global system for mobile communications (GSM), Enhanced Data GSM Environment (EDGE), etc.

Example Configurable Top-Level Graphical User Interface

FIG. 2B illustrates another example of configurable top-level graphical user interface of device 106. The device 106 can be configured to display a different set of display objects.

In some implementations, each of one or more system objects of device 106 has a set of system object attributes associated with it; and one of the attributes determines whether a display object for the system object will be rendered in the top-level graphical user interface. This attribute can be set by the system automatically, or by a user through certain programs or system functionalities as described below. FIG. 2B shows an example of how the Notes object 252 (not shown in FIG. 2A) is added to and the Web Video object 216 is removed from the top graphical user interface of device 106 (e.g. such as when the attributes of the Notes system object and the Web Video system object are modified).

Example Mobile Device Architecture

FIG. 3 is a block diagram 300 of an example implementation of a mobile device 106. As shown, the mobile device can include a memory interface 302, one or more data processors, image processors and/or central processing units 304, and a peripherals interface 306. The memory interface 302, the one or more processors 304 and/or the peripherals interface 306 can be separate components or can be integrated in one or more integrated circuits. The various components in the mobile device can be coupled by one or more communication buses or signal lines.

Sensors, devices, and subsystems can be coupled to the peripherals interface 306 to facilitate multiple functionalities. For example, a motion sensor 310, a light sensor 312, and a proximity sensor 311 can be coupled to the peripherals interface 306 to facilitate the orientation, lighting, and proximity functions described with respect to FIG. 2A. Other sensors 316 can also be connected to the peripherals interface 306, such as a positioning system (e.g., GPS receiver), a temperature sensor, a biometric sensor, or other sensing device, to facilitate related functionalities.

A camera subsystem 320 and an optical sensor 322, e.g., a charged coupled device (CCD) or a complementary metal-oxide semiconductor (CMOS) optical sensor, can be utilized to facilitate camera functions, such as recording photographs and video clips.

Communication functions can be facilitated through one or more wireless communication subsystems 324, which can include radio frequency receivers and transmitters and/or optical (e.g., infrared) receivers and transmitters. The specific design and implementation of the communication subsystem 324 can depend on the communication network(s) over which the mobile device is intended to operate. For example, a mobile device can include communication subsystems 324 designed to operate over a GSM network, a GPRS network, an EDGE network, a Wi-Fi or WiMax network, and a Bluetooth™ network. In particular, the wireless communication subsystems 324 may include hosting protocols such that the mobile device may be configured as a base station for other wireless devices.

An audio subsystem 326 can be coupled to a speaker 328 and a microphone 330 to facilitate voice-enabled functions, such as voice recognition, voice replication, digital recording, and telephony functions.

The I/O subsystem 340 can include a touch screen controller 342 and/or other input controller(s) 344. The touch-screen controller 342 can be coupled to a touch screen 346. The touch screen 346 and touch screen controller 342 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen 346.

The other input controller(s) 344 can be coupled to other input/control devices 348, such as one or more buttons, rocker switches, thumb-wheel, infrared port, USB port, and/or a pointer device such as a stylus. The one or more buttons (not shown) can include an up/down button for volume control of the speaker 328 and/or the microphone 330.

In one implementation, a pressing of the button for a first duration may disengage a lock of the touch screen 346; and a pressing of the button for a second duration that is longer than the first duration may turn power to the mobile device on or off. The user may be able to customize a functionality of one or more of the buttons. The touch screen 346 can, for example, also be used to implement virtual or soft buttons and/or a keyboard.

In some implementations, the mobile device can present recorded audio and/or video files, such as MP3, AAC, and MPEG files. In some implementations, the mobile device can include the functionality of an MP3 player, such as an iPod™. The mobile device may, therefore, include a 32-pin connector that is compatible with the iPod™. Other input/output and control devices can also be used.

The memory interface 302 can be coupled to memory 350. The memory 350 can include high-speed random access memory and/or non-volatile memory, such as one or more magnetic disk storage devices, one or more optical storage devices, and/or flash memory (e.g., NAND, NOR). The memory 350 can store an operating system 352, such as Darwin, RTXC, LINUX, UNIX, OS X, WINDOWS, or an embedded operating system such as VxWorks. The operating system 352 may include instructions for handling basic system services and for performing hardware dependent tasks. In some implementations, the operating system 352 can be a kernel (e.g., UNIX kernel).

The memory 350 may also store communication instructions 354 to facilitate communicating with one or more additional devices, one or more computers and/or one or more servers. The memory 350 may include graphical user interface instructions 356 to facilitate graphic user interface processing; sensor processing instructions 358 to facilitate sensor-related processing and functions; phone instructions 360 to facilitate phone-related processes and functions; electronic messaging instructions 362 to facilitate electronic-messaging related processes and functions; web browsing instructions 364 to facilitate web browsing-related processes and functions; media processing instructions 366 to facilitate media processing-related processes and functions; GPS/Navigation instructions 368 to facilitate GPS and navigation-related processes and instructions; camera instructions 370 to facilitate camera-related processes and functions; and/or other software instructions 372 to facilitate other processes and functions, e.g., access control management functions. The memory 350 may also store other software instructions (not shown), such as web video instructions to facilitate web video-related processes and functions; and/or web shopping instructions to facilitate web shopping-related processes and functions. In some implementations, the media processing instructions 366 are divided into audio processing instructions and video processing instructions to facilitate audio processing-related processes and functions and video processing-related processes and functions, respectively. An activation record and International Mobile Equipment Identity (IMEI) 374 or similar hardware identifier can also be stored in memory 350.

Each of the above identified instructions and applications can correspond to a set of instructions for performing one or more functions described above. These instructions need not be implemented as separate software programs, procedures, or modules. The memory 350 can include additional instructions or fewer instructions. Furthermore, various functions of the mobile device may be implemented in hardware and/or in software, including in one or more signal processing and/or application specific integrated circuits.

FIG. 4 illustrates a conceptual block diagram of an environment on the computing device 106 that supports customized access to a source of software. As shown, in order to implement secure installation of software, the computing device 106 may comprise an installer 400, an operating system 402, an installation framework 404, storage 406, one or more containers 408 arranged in a directory structure, a content management application 416, one or more profiles 418 comprising authorization data 420, and a profile database 422. These components will now be further described.

Installer 400 is a program or process that installs files, such as applications, drivers, or other software, on computing device 106. In some embodiments, installer 400 is configured to read and analyze the contents of a software package to be installed, such as a software package from source 102.

A software package from source 102 may have a specific format and information that is used by installer 400. In particular, a software package may include the software's full name, a unique identifier for the software, a description of its purpose, version number, vendor, checksum, and a list of dependencies necessary for the software to run properly. Upon installation, installer 400 may also store metadata about the software.

In addition, the installer 400 may be interfaced based on a predetermined application programming interface (API). In one embodiment, the API comprises functions to install an application, uninstall an application, archive an application, and list installed applications. The API can also provide functions that instruct installer 400 to verify application installation and access restrictions at run time. In some embodiments, the API for the installer 400 may provide primitives for these functions via a trusted portion of the operating system 402, such as the kernel 410.

Operating system 402 generally serves as an interface between hardware and the user. In particular, operating system 402 may be responsible for the management and coordination of activities and the sharing of the resources of the computing device 106. Operating system 402 primarily acts as a host for applications, and thus, includes instructions that handle the details of the operation of the hardware of the computing device 106.

In addition, operating system 402 may offer a number of services to application programs and users. The applications running on computing device 106 may access these services through APIs or system calls. For example, by calling an API function, an application can request a service from the operating system 402, pass parameters, and receive the results of the operation.

In some embodiments, operating system 402 may be like operating system 352, shown in FIG. 3. Accordingly, operating system 402 may be an operating system, such as Darwin, RTXC, LINUX, UNIX, OS X, WINDOWS, or an embedded operating system such as VxWorks.

Kernel 410 is the central trusted component of operating system 402. The functions of kernel 410 responsibilities include managing the resources, such as the resources shown in FIGS. 2A-2B and FIG. 3. In particular, kernel 410 provides access to resources, such as the memory 350, processor(s) 304, and I/O subsystems 340 of computing device 106. In general, kernel 410 may employ API system calls and inter-process communications to perform its function.

Trusted cache 412 is a temporary storage area where frequently accessed data, such as randomly assigned identifiers for containers 408, can be stored for rapid access. For example, cache 412 may be implemented in memory 350 of computing device 106. Furthermore, trusted cache 412 may be maintained in a trusted space of memory 350 in order to secure its information. In some embodiments, access to trusted cache 412 may be limited to certain components, such as kernel 410.

Installation framework 404 is a library file that controls how applications are securely installed on the computing device 106 and the management of the securely installed applications. In some embodiments, the installation framework 404 restricts where and how applications can be installed on the computing device 106. For example, the installation framework 404 may contain supporting programs, libraries, or references to other files.

Storage 406 may be any data storage device, such as a hard disk, memory, optical disk, etc. for computing device 106. In some embodiments, information is stored in storage 406 based on a known file system and directory structure. Such file systems and directory structures are known to those skilled in the art.

Of note, however, the various embodiments may employ directories having randomly assigned identifiers or names. In particular, these random identifiers provide a level of indirection that helps allow the installation framework 404 control the installation and execution of software within its container. The random identifiers are unknown to the application itself and known only to the installation framework 404. This mechanism provides the operation system 402 a point of control that ensures the behavior of an application's installation and execution.

Containers 408 refer to any collection of resources that are used store the program code of a software application and used by the application running on computing device 106, such as disk space on storage 406 and/or memory space in memory 350. In some embodiments, containers 408 may comprise a directory that refers to a specific area of storage 406 on the device 106. Data specific to the software application including code storage, documents, preferences, and other libraries are stored and restricted to the containers 408.

In order to enhance security, containers 408 can employ randomly assigned identifiers, such as random directory names, that are unknown to the application. One advantage, among others, is that the application is prevented from becoming a security risk since the application does not directly control its resources or directory space. As noted, the installer 400 may use randomly assigned identifiers for the containers 408. The random identifiers may be based on various functions, such as a hash function of information provided in the application's package, some other type of cryptographic function, and the like. In addition, the random identifiers for the containers 408 may be based on various unique attributes of the software. For example, unique application identifiers in the form of com.domain.email may be used in determining the random identifier for the container 408. In some embodiments, the installer 400 stores this information only in trusted cache 412.

During execution, a software application may also be restricted in various ways to its containers 408. For example, containers 408 may comprise a set of resource limits imposed on programs by kernel 410, such as I/O bandwidth caps, disk quotas, network access restrictions, and as noted above a restricted directory namespace known only to the installation framework 404.

Content management application 414 is an application that allows the user to manage content, such as audio, video, and applications, downloaded and installed on computing device 106. Content management application 414 may also provide a front-end interface when accessing source 102.

Content management application 414 may provide various functions that allow users to organize applications and content downloaded on to computing device 106. Content management application 414 may keep track of the content and applications by creating a virtual library having metadata attributes.

For example, content management application 414 may update various files whenever information about content and applications are downloaded or changed. Content management application 414 may also support a wide variety of file types for its content and applications. Such file types are well known to those skilled in the art.

Profiles 416 may be a set of data stored on the device 106, which indicates authorizations granted or provided to the device. As shown, profiles 416 may include a digital signature 418 and authorization data 420. Profiles 416 may also include other data, such as device identifier data, user identifier data, etc.

In some embodiments, profiles 416 may be authenticated through the use of one or more digital signatures. For example, profiles 416 may indicate that certain applications from a particular entity are eligible for download. Accordingly, this may recorded in profiles 416 by having that entity digitally sign one or more portions of the profile 416. As is known in the art, a digital signature can use public key cryptography to ensure the integrity of data. For example, an entity may provide source 102 with compiled object code. That entity may then create a digital signature with its private key, which is included in the profile 416.

Authorization data 420 may include data, which indicates the types of applications and content that are eligible for download to the computing device 106. Authorization data 420 may identify applications and content according to various criteria, such as specific identification, a rating, a file type, size, operational parameters, resource limits, etc. Authorization data 420 may take the form of key-value pairs. The values may include, for example, numeric, Boolean, or alphanumeric data. In one embodiment, authorization data 420 may include an array or other data structure of predefined Boolean variables, which are indicative of various specified authorizations or applications. For example, an authorization data 420 may include a data structure in tabular form such as illustrated in Table 1 below.

TABLE 1
Example Authorization Data

| | |
|---|---|
| Key | 5551234 |
| Application ID1 | 123FFF |
| Application ID2 | 456FDF |
| Executable | TRUE |
| Code Digest | AAFF1144BB |

Profile database 422 serves as a data structure or list that assists content management application 414 in determining which front-end interfaces 108A-N are to be selected. For example, content management application 414 may need to process multiple profiles 416 and authorization data 420. Some of authorization data may be in the form of a white list, e.g., indicating various applications and front-end interfaces 108A-N that are permissible. However, other authorization data may be in the form of data disallowing certain interfaces 108A-N or applications. Accordingly, profile database 422 provides a data structure to finely control particular authorization data 420 or to resolve conflicting authorization data 420.

FIGS. 5A and 5B illustrate an exemplary process flow for providing a customized front-end interface to a source of software and installing an application from the source. As shown, this process may generally comprise eleven operations. However, one skilled in the art will recognize that other steps and different orders of steps are consistent with the present invention.

First, a user of the computing device 106 may request to browse source 102 for applications that are eligible for download and installation. For example, a user of mobile computing device (such as an iPhone or iTouch) may select the “App Store” icon to indicate a desire to connect to the iTunes store.

Second, the content management application 414 identifies and analyzes the profiles on computing device 106. In particular, content management application 414 may access profiles 416 and analyze the contents of digital signature 418 and authorization data 420.

Third, the content management application 414 determines which of front-end interfaces 108A-N is appropriate based on the authorization indicated in the profile 416. Content management application 414 may reference profile database 422 based on the information found in profile 416. For example, various front-end interfaces 108A-N may be selected based on the identity of the signer of the digital signature 418. Content management application 414 may also determine which front-end interfaces 108A-N are appropriate based on the values indicated in the authorization data 420.

Fourth, the content management application 414 connects to the appropriate front-end interfaces 108A-N. In particular, content management application 414 may utilize the network connectivity features of computing device 106 to connect to source 102. For example, content management application 414 may connect to a website or online service, such as iTunes Store via the Internet.

Fifth, the front-end interfaces 108 determine which applications in source 102 are eligible to be downloaded and installed on to computing device 106. For example, a request may be received by computing device 106 to install one or more eligible applications from source 102 via front-end interface 108A. For example, a user of computing device 106 may access source 102 and select one or more applications for download and installation.

Then, sixth, source 102 may then provide a package for the selected software to be installed on the computing device 106. As noted, the package may include the software's full name, a unique identifier for the software, a description of its purpose, version number, vendor, checksum, and a list of dependencies necessary for the software to run properly. For example, in the example shown in FIG. 5A, the requested application has a unique identifier of “ABCD.”

Referring now to FIG. 5B, seventh, upon receiving this package, operating system 402 may execute installer 402 as a running process to perform the installation of the requested software.

Eighth, installer 400 determines a container 408 for the application. For example, installer 400 may randomly assign an identifier or name for a directory that is to be used as container 408 for the application, e.g., application ABCD. For example, installer 400 may perform various cryptographic functions to determine/generate a random identifier for container 408. Such cryptographic functions are known to those skilled in the art. In some embodiments, installer 400 may employ a hashing function that is based on information from the package in order to determine/generate the random identifier for container 408. In addition, installer 400 may utilize various arbitrary attributes of the software to determine the random identifier. In the example shown in FIG. 5B, installer 400 has generated “1AFF2” as the random identifier for the container 408.

Ninth, installer 400 makes a call to installation framework 404. In response, installation framework 404 may record the random identifier and associate it with the application. In addition, installation framework 404 may determine various constraints, such as I/O limits, storage space, etc., for the requested application in container 408.

Tenth, installer 400 and/or installation framework 404 installs the program code, etc. in its container 408. In some embodiments, each application is given one container 408. For example, installer 400 may call installation framework 404 and install compiled code in storage 406.

Next, the identifier for container 408 is stored in trusted cache 412 for later use by operating system 402, kernel 410 and/or installation framework 404. For example, installation framework 404 may record an entry in trusted cache 412 that correlates application “ABCD” with container identifier “1AFF2” for container 408. Of course, the operating system 402, kernel 410 or installation framework 404 may utilize other bind processes to correlate the randomly assigned identifier with the application being installed.

In addition to the process described above, when a request to install the software is received, computing device 106 can also check a digital signature of the software or software package to verify its authenticity and/or authorization. If the software is verified as being signed by a trusted authority, installer 400 and/or installation framework 404 may also permit installation of the computing device 106 as additional or alternative criteria for allowing installation.

FIG. 6 illustrates an exemplary process for managing and synchronizing securely installed software on the computing device 106. In general, the installation framework 404 manages the launching and execution of applications being executed on the computing device 106. In particular, the installation framework 404 provides a mechanism by which the operating system 402 identifies and locates the container 408 for an application.

When an application is launched, the application framework performs a search for that application's randomly assigned identifier and locates the application's container. The application is then allowed to execute within its container. During execution, the software application may also be restricted in various ways by the installation framework to its dynamic containers. The installer may also work with a trusted operating system component, such as the kernel, to help enforce the container restrictions.

In addition, if desired, the use of random identifiers for containers may be used in conjunction with other security mechanisms. For example, the operating system of the computing device may be configured to determine whether the code has been authorized by a trusted authority.

For example, a trusted authority may authorize software for installation and/or execution by digitally signing the software. As is known in the art, a digital signature uses public key cryptography to ensure the integrity of data. If the code is authorized and verified as such, it may be generally executed without any further system or user interaction; if the code is not authorized, its ability to be executed on the computing device may be restricted or even prevented.

In some embodiments, the computing device may alert the user that the code is not authorized and ask the user if they still wish to execute the unauthorized code. In other embodiments, the computing devices may be configured to prevent unauthorized code from being executed at all, regardless of the user's wishes.

Referring now to FIG. 6, first, computing device 106 receives a request to launch or execute an application that has been securely installed on computing device 106. For example, a user of computing device 106 may select an application installed on the computing device. In the example shown in FIG. 6, application “ABCD” has been selected by the user using a peripheral, such as a touch screen, etc. This information may then be passed via peripheral interface 348 to operating system 402.

Second, operating system 402 services this request. For example, operating system 402 may instruct kernel 410 to execute the requested application, e.g., application “ABCD.” Because this application has been securely installed, the location of container 408 is unknown or initially beyond the control of the application.

Accordingly, third, kernel 410 makes a call to installation framework 404 requesting the identifier for container 408 for application “ABCD.” Fourth, installation framework 404 may then perform a search for the container 408 for the requested application and then responds with the identifier for container 408, e.g., “1AFF2.”

For example, kernel 410 may perform a comparison of this unique identifier with the information stored in trusted cache 412. For example, kernel 410 may perform a text comparison to determine whether the identifier matches an entry that is stored in trusted cache 412.

If the information does not match what is stored in trusted cache 412, then operating system 402 may deny the application and/or prompt the user for a response. For example, the operating system 402 may provide a warning message that the application could not be found by installation framework 404.

If the information matches what is stored in trusted cache 412, then, fifth, kernel 410 continues its service of the application. In particular, the application is allowed to execute on computing device 106 within the constraints of its container 408.

In addition to the process described above, when a request to execute the software is received, computing device 106 can also check a digital signature of the software to verify its authenticity and/or authorization. If the software is verified as being signed by a trusted authority, installation framework 404 may use this verification as additional or alternative criteria for allowing execution.

It is pertinent to point out that the specific structures and sequences described above may be implemented/performed with alternative structures and sequences. Therefore, the teachings of the above description should not be construed as being limited to the specific structures and/or sequences described above.

Those of skill may recognize that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

While the above detailed description has shown, described, and pointed out novel features of the invention as applied to various embodiments, it will be understood that various omissions, substitutions, and changes in the form and details of the device or process illustrated may be made by those skilled in the art without departing from the spirit of the invention. As will be recognized, the present invention may be embodied within a form that does not provide all of the features and benefits set forth herein, as some features may be used or practiced separately from others. The scope of the invention is indicated by the appended claims rather than by the foregoing description. All changes, which come within the meaning and range of equivalency of the claims are to be embraced within their scope.

What is claimed is:

1. A method of customizing access to a set of software for download to a computing device, wherein the computing device comprises at least one profile indicating a set of authorizations provided to the computing device, the method comprising:
receiving a request to access a source of software comprising one or more sets of applications that can be downloaded via respective front-end interfaces of the source to the computing device;
authenticating at least one profile stored on the computing device;
determining, for the at least one profile, a set of authorizations granted to the computing device;
identifying at least one of the front-end interfaces that provide access to software from the source that are eligible for download to the computing device based on the set of authorizations in the at least one profile; and
providing access to the software that are eligible for download via the identified at least one front-end interface.

2. The method of claim 1, wherein the at least one profile of the service provider comprises one or more authorizations indicating applications that are disallowed download to the computing device.

3. The method of claim 1, wherein authenticating the at least one profile comprises verifying a cryptographic signature included in the at least one profile.

4. The method of claim 3, wherein authenticating the at least one profile comprises authenticating the cryptographic signature based on a cryptographic key of an entity that signed the software that is eligible for download to the computing device.

5. The method of claim 1, wherein authenticating the cryptographic signature of the digest comprises:
calculating a cryptographic signature of the digest based on a public key of a trusted entity; and
comparing the calculated signature with a cryptographic signature stored in the at least one profile.

6. The method of claim 1, wherein the applications considered eligible for download are selected based at least in part on the identity of the signer of the at least one profile.

7. The method of claim 1, wherein providing access to the software that is eligible for download comprises access via a front-end interface provided to a mobile device.

8. The method of claim 7, wherein providing access to the software that are eligible for download comprises access via a front-end interface provided to a host computer capable of communicating with the mobile device.

9. A computing device configured to customize access to a set of software for download to the computing device, said device comprising:
a storage storing at least one profile indicating a set of authorizations provided to the computing device; and
a processor configured to receive a request to access a source of software comprising one or more sets of applications that can be downloaded via respective front-end interfaces of the source to the computing device, authenticate at least one profile stored on the computing device, determine for the at least one profile, a set of authorizations granted to the computing device, identify at least one of the front-end interfaces that provide access to software from the source that are eligible for download to the computing device based on the set of authorizations in the at least one profile, and provide access to the software that are eligible for download via the identified at least one front-end interface.

10. The computing device of claim 9, wherein the at least one profile of the service provider comprises one or more authorizations indicating applications that are disallowed download to the computing device.

11. The computing device of claim 9, wherein the processor is configured to verify a cryptographic signature included in the at least one profile.

12. The computing device of claim 9, wherein the processor is configured to authenticate the cryptographic signature based on a cryptographic key of an entity that signed the software that is eligible for download to the computing device.

13. The computing device of claim 9, wherein the processor is configured to authenticate the cryptographic signature of the digest based on calculating a cryptographic signature of the digest based on a public key of a trusted entity and comparing the calculated signature with a cryptographic signature stored in the at least one profile.

14. The computing device of claim 9, wherein the processor is configured to determine which applications are eligible for download based at least in part on the identity of the signer of the at least one profile.

15. The computing device of claim 9, wherein the computing device is a mobile device configured to provide access via a front-end interface to the source of software.

16. The computing device of claim 9, wherein the computing device is a host computer coupled with a mobile device to provide access via a front-end interface to the source of software.

17. A method performed by a device, comprising:
receiving a profile identifying an interface of a source for software items, said interface particular to the set of software items that said device has been pre approved to access;
storing said profile on said device;
in response to a user desiring to access said source, instantiating said interface on said device; and,
retrieving a software item from the set with said interface.

18. The method of claim 17 further comprising installing said software on said device.

19. The method of claim 17 wherein said profile is signed by an entity that provides said software items.

20. The method of claim 17 where said first interface is customized for a user of said first device in terms of any of:
age;
ethnicity;
location;
interest.

21. The method of claim 17 wherein said profile contains authorization data for accessing said set of software items.

22. The method of claim 21 wherein said profile further contains any of:
an identifier of said device;
an identifier of said user.

23. A method, comprising:
identifying a set of software items that are to be made available to a device;
constructing a profile that identifies an interface through which said set of software items can be retrieved;
providing said profile to said device;
receiving a request to retrieve a member of said set through an instance of said interface, said request originating from said device, information from said profile being used to create said instance; and,
downloading said member to said device.

24. The method of claim 23 further comprising:
identifying a second set of software items that are to be made available to a second device, said second set being different than said first set;
constructing a second profile that identifies a second interface through which said second set of software items can be retrieved;
providing said second profile to said second device;
receiving a second request to retrieve a member of said second set through an instance of said second interface, said second request originating from said second device, said instance of said second interface created with information from said second profile; and,
downloading said member of said second set to said second device.

25. The method of claim 24 wherein said first and second devices are associated with different users.

26. The method of claim 24 wherein said first and second sets are associated with different entities.

27. The method of claim 24 where said first interface is customized for said first user in terms of any of:
age;
ethnicity;
location;
interest.

28. The method of claim 23 wherein said constructing of said profile further comprises digitally signing said profile with a signature of an entity that provides software items.

29. A machine readable medium containing program code that when processed by a digital processing unit of a device causes a method to be performed by that device, said method comprising:
receiving a profile identifying an interface of a source for software items, said interface particular to the set of software items that said device has been pre approved to access;
storing said profile on said device;
in response to a user desiring to access said source, instantiating said interface on said device; and,
retrieving a software item from the set with said interface.

30. The machine readable medium of claim 29 wherein said method further comprises installing said software on said device.

31. The machine readable medium of claim 29 wherein said profile is signed by an entity that provides said software items.

32. The machine readable medium of claim 29 where said first interface is customized for a user of said first device in terms of any of:
age;
ethnicity;
location;
interest.

33. The machine readable medium of claim 29 wherein said profile contains authorization data for accessing said set of software items.

34. The machine readable medium of claim 33 wherein said profile further contains any of:
an identifier of said device;
an identifier of said user.

35. A machine readable medium containing program code that when processed by a digital processing unit of a server causes a method to be performed by that server, said method comprising:
identifying a set of software items that are to be made available to a device;
constructing a profile that identifies an interface through which said set of software items can be retrieved;
providing said profile to said device;
receiving a request to retrieve a member of said set through an instance of said interface, said request originating from said device, information from said profile being used to create said instance; and,
downloading said member to said device.

36. The machine readable medium of claim 35 wherein said method further comprises:
identifying a second set of software items that are to be made available to a second device, said second set being different than said first set;
constructing a second profile that identifies a second interface through which said second set of software items can be retrieved;
providing said second profile to said second device;
receiving a second request to retrieve a member of said second set through an instance of said second interface, said second request originating from said second device, said instance of said second interface created with information from said second profile; and,
downloading said member of said second set to said second device.

37. The machine readable medium of claim 36 wherein said first and second devices are associated with different users.

38. The machine readable medium of claim 36 wherein said first and second sets are associated with different entities.

39. The machine readable medium of claim 36 where said first interface is customized for said first user in terms of any of:
age;
ethnicity;
location;
interest.

40. The machine readable medium of claim 35 wherein said constructing of said profile further comprises digitally signing said profile with a signature of an entity that provides software items.

41. A device having a processing unit and program code stored on a storage device of said device, said program code to perform a method when executed by said processing unit, said method, comprising:
receiving a profile identifying an interface of a source for software items, said interface particular to the set of software items that said device has been pre approved to access;
storing said profile on said device;
in response to a user desiring to access said source, instantiating said interface on said device; and,
retrieving a software item from the set with said interface.

42. The device of claim 41 wherein said method further comprises installing said software on said device.

43. The device of claim 41 wherein said profile is signed by an entity that provides said software items.

44. The device of claim 41 where said first interface is customized for a user of said first device in terms of any of:
age;
ethnicity;
location;
interest.

45. The device of claim 41 wherein said profile contains authorization data for accessing said set of software items.

46. The device of claim 45 wherein said profile further contains any of:
an identifier of said device;
an identifier of said user.

47. A server having a processing unit and program code stored on a storage device of said server, said program code to perform a method of a host that is implemented on said server when executed by said processing unit, said method, comprising:
identifying a set of software items that are to be made available to a device;
constructing a profile that identifies an interface through which said set of software items can be retrieved;
providing said profile to said device;
receiving a request to retrieve a member of said set through an instance of said interface, said request originating from said device, information from said profile being used to create said instance; and,
downloading said member to said device.

48. The server of claim 47 wherein said method further comprises:
identifying a second set of software items that are to be made available to a second device, said second set being different than said first set;
constructing a second profile that identifies a second interface through which said second set of software items can be retrieved;
providing said second profile to said second device;
receiving a second request to retrieve a member of said second set through an instance of said second interface, said second request originating from said second device, said instance of said second interface created with information from said second profile; and,
downloading said member of said second set to said second device.

49. The server of claim 48 wherein said first and second devices are associated with different users.

50. The server of claim 48 wherein said first and second sets are associated with different entities.

51. The server of claim 48 where said first interface is customized for said first user in terms of any of:
age;
ethnicity;
location;
interest.

52. The server of claim 47 wherein said constructing of said profile further comprises digitally signing said profile with a signature of an entity that provides software items.
